(19) United States
(12) Patent Application Publication
(10) Pub. No.: US 2003/0007816 A1
(43) Pub. Date: Jan. 9, 2003

(54) Image reading apparatus and image reading method

(76) Inventors: Shuji Ishimaru, Kofu-shi (JP); Kouji Ogino, Yamanashi-ken (JP)

Correspondence Address: KANESAKA AND TAKEUCHI, 1423 Powhatan Street, Alexandria, VA, 22314, US

(21) Appl. No.: 10/189,191

(22) Filed: Jul. 5, 2002

(30) Foreign Application Priority Data
Jul. 5, 2001 (JP) 2001-204942

(51) Int. Cl. G03G 15/00

(52) U.S. Cl. 399/367

(57) ABSTRACT

An image reading apparatus is provided with an supply device for supplying an original on a supply tray; a transport device for transporting the original to a platen; a discharge device for discharging the original; an optical reading device for scanning the original placed on the platen; a drive device for moving the optical reading device at the first moving speed or the second moving speed; and a detection device for determining a type of image data as either the first type of data or the second type of data. A scan control device obtains and stores image data while scanning a document at the first moving speed. A switching control device switches the drive device to the second moving speed when the detecting device determines the image data read at the first moving speed to be the second type of data.

### BACKGROUND OF THE INVENTION AND RELATED ART STATEMENT

The present invention relates to an image reading apparatus in which a transport device transports and sets an original on a platen, and an image on the original is scanned and read. More particularly, the present invention relates to an image reading apparatus and an image reading method that are capable of reading a set of originals including both a black and white (monotone) original and a color original at a higher reading speed.

In recent years, as more personal computers are used to handle color pictures on the internet and electronic photos, there has been an increasing demand for copying, printing and transmitting color images because of superior quality as opposed to black and white images. For that reason, an image reading apparatus has been required to quickly read a color original with high quality.

When an image reading apparatus reads a color original, normally it is necessary to read image data for each of the three primary colors, namely red (R), green (G) and blue (B). Thus, when reading a color original with the same resolution as a black and white original, the image reading apparatus has to read at a slower reading speed than that for a black and white original.

A set of originals to be read in the image reading apparatus may contain both color originals and black and white originals. When the apparatus read such a set of originals using the color mode, a speed of reading the black and white originals will be dramatically slowed.

To solve this problem, a conventional apparatus pre-scans an original to determine whether the original is in black and white or color. Then, if the original is only in black and white, the image reading apparatus reads at a high speed in the black and white reading mode. Conversely, if the original is in color, it uses the color reading mode with a slower speed. This system is known as ‘pre-scan/actual scan method’.

In Japanese Patent Publication (KOKAI) No. 09-261417, an image processing apparatus is disclosed as a modified version of the ‘pre-scan/actual scan method’ that requires two passes of an original. According to the invention, the reading apparatus is provided with a cycling automatic document feeder. It is determined whether the original is in black and white or color for all documents in advance through a process of transporting the originals through a reading position inside the apparatus. After storing a result of each page of the originals, a stationary reading means reads the originals in black and white at a high speed scanning. Conversely, a moving reading unit scans and reads the originals in color placed stationary on a platen to provide a higher quality.

In Japanese Patent Publication (KOKAI) No. 2001-24850, an image reading apparatus is provided with a color detection device to determine whether an original is in black and white or color. Before reading the original, it is selected to read the original in a color reading mode or in a black and white reading mode. The image reading apparatus reads the original only when a result of the color detection device matches to the reading mode.

However, in the image reading apparatus with ‘pre-scan/actual scan method’ including the one disclosed in Japanese Patent Publication (KOKAI) No. 09-261417, the pre-scan needs to detect whether the original is in monotone or color in advance of the actual scan to read the originals, so it takes longer reading time for the entire originals having both monotone and white documents.

Further, when the apparatus disclosed in Japanese Patent Publication (KOKAI) No. 2001-24850 is set to read in the color mode, monotone originals will not be read if the monotone originals are included in a set of the originals. Therefore, it is necessary to reset the apparatus in the monotone reading mode and read the originals in monotone one more time. Due to the additional time, the reading time for the entire set of originals also takes long.

The first objective of the present invention is to provide an image reading apparatus that is equipped with a transport device for supplying and setting originals drawn out from a sheet supply device at a predetermined position on a platen. The apparatus is capable of reading using both a transporting original reading method and a stationary original reading method. The image reading apparatus and the image reading method can read a set of originals containing both color and monotone documents in a shorter period of time. The apparatus has a detection function for color and monotone originals, and reads the monotone documents in a higher speed mode and the color documents in a higher quality mode.

The second object of the present invention is to provide an apparatus that reads the original in the monotone reading mode when the apparatus determines a type of image. The apparatus reads the original one more time in the stationary original reading mode, which corresponds to the color reading mode, only when the original has an color image. The monotone original is discharged after the initial color detection run to reduce the reading time for the monotone original, which relatively has the higher number in a set of originals than the color original. The invention improves a production speed of an image forming apparatus from reading to printing.

Further objects and advantages of the invention will be apparent from the following description of the invention.

### SUMMARY OF THE INVENTION

In order to attain the aforementioned objects, an image reading apparatus of the present invention is provided with an supply device for supplying an original on a supply tray; a transport device for transporting the original supplied from the supply tray to a platen; a discharge device for discharging the original on the platen; an optical reading device for scanning the stationary original placed on the platen to read an image on the original; a drive device for moving the optical reading device at the first moving speed or the second moving speed; a detection device for determining a type of image data read by the optical reading device as either the first type of data or the second type of data; a scan control device for obtaining and storing image data while scanning a document at the first moving speed; and a switching control device for switching the drive device to the second moving speed when the detecting device determines the image data read at the first moving speed to be the second type of data.

In the first reading mode, the optical reading device is stationary under the platen, and reads the original that is transported and moving on the first reading position. In the second reading mode, the optical reading device reads the original that is set at the second reading position on the platen while the optical reading device is moving. A reading speed in the first reading mode is faster than that in the second reading mode. The first reading mode is for reading monotone images, and the second reading mode is for reading color images.

When reading an image on a monotone original, the image data obtained in the initial reading operation will be used, thereby eliminating the second scanning. Therefore, it is possible to read a set of originals containing both monotone originals and color originals at a higher speed. Also, the apparatus reads a color original with a higher quality in the actual scanning (the second reading operation).

### BRIEF DESCRIPTION OF THE DRAWINGS

FIG. 1 is a view showing an image reading apparatus having a transport device and an image reading unit with one carriage according to the present invention;

FIG. 2 is a view showing a movement of the carriage of the image reading apparatus in FIG. 1;

FIG. 3 is a view showing an image reading apparatus having a transport device and an image reading unit with two carriages according to the present invention;

FIG. 4 is a view showing a movement of the carriage of the image reading apparatus in FIG. 3;

FIG. 5 is a view showing an arrangement of drive motors for transporting an original in the image reading apparatus;

FIG. 6(a) is a graph showing a relationship between relative sensitivity and wavelength of color for each sensor, and FIG. 6(b) is a graph showing spectral reflectance data of a monotone document;

FIG. 7 is a diagram of a circuit configuration in an image signal control unit using four line image sensors including a black and white sensor;

FIG. 8 is a diagram of a circuit configuration in an image signal control unit using three line image sensors;

FIG. 9 is a chart showing a reading mode of the image reading apparatus;

FIG. 10 is a flow chart showing the first operation control method of the image reading apparatus; and

FIG. 11 is a flow chart showing the second operation control method of the image reading apparatus.

### DETAILED DESCRIPTION OF THE PREFERRED EMBODIMENT

Hereunder, preferred embodiments of the present invention will be explained in detail with reference to the accompanied drawings.

An image reading apparatus according to the present invention is composed of a transport device 1 constituting a document transport unit and a reading device 2 constituting an image reading unit. The transport device 1 is mounted on the reading apparatus body via a hinge, etc. (not shown in the drawings) to open and close with respect to a platen disposed on an upper portion of the reading device 2.

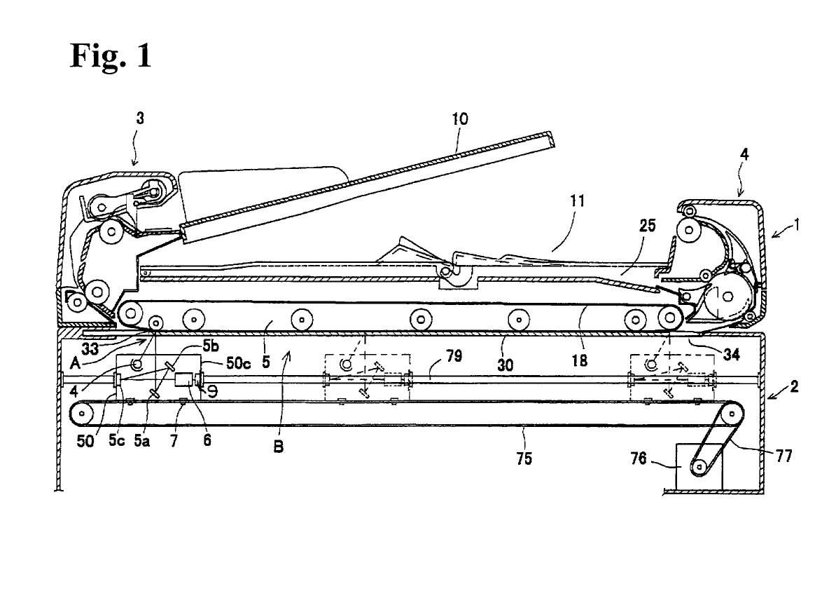

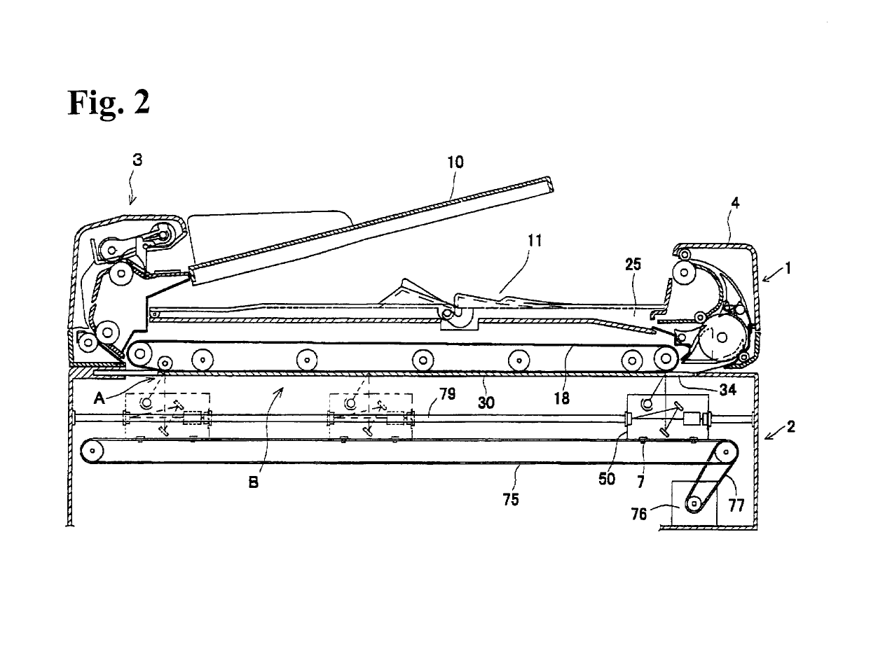

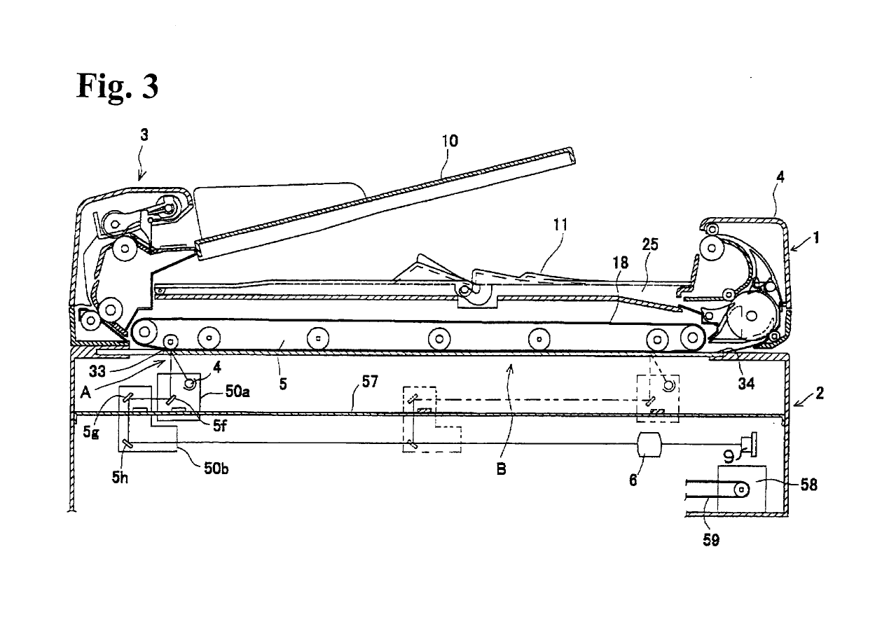

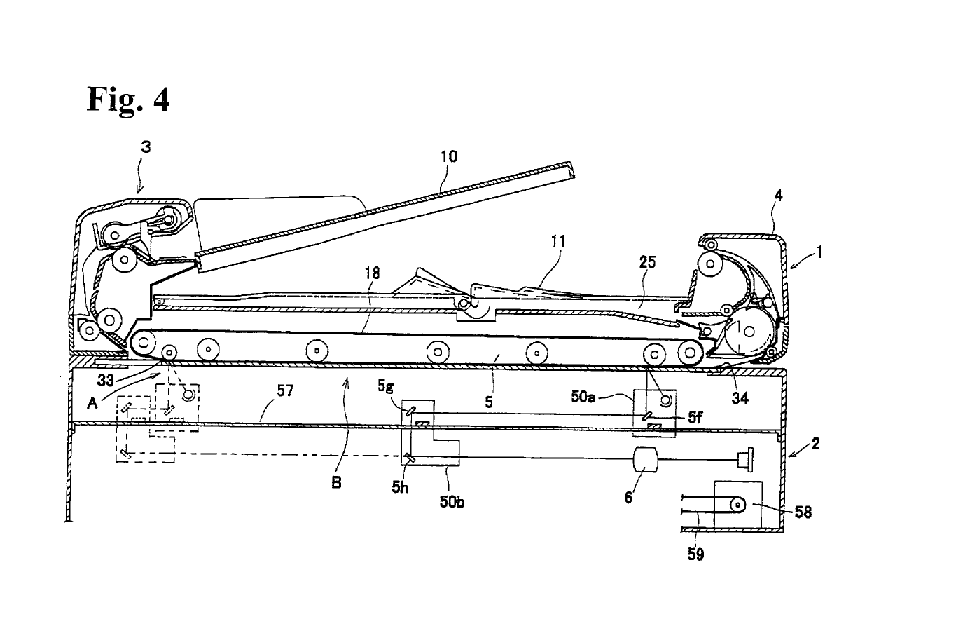

FIG. 1 and FIG. 2 show the first embodiment of the transport device 1 and the reading device 2. FIG. 3 and FIG. 4 show a sectional view of the second embodiment of the transport device 1 and the reading device 2. According to the invention, the transport device 1 is composed of a sheet supply device, a transport device and a discharge device.

As shown in FIG. 1 and FIG. 2, the transport device 1 is provided with a support frame; a sheet supply tray 10; a sheet supply unit 3 disposed on one side of the support frame for drawing an original stacked on the sheet supply tray 10; a transport unit 5 for receiving the original drawn from the sheet supply unit 3 and transporting it to a predetermined position on a platen top 30 of the reading device 2 located below the sheet supply unit 3; a discharge unit 4 for discharging the original after reading images to the other side of the support frame; and a discharge tray 11 for stacking the discharged originals.

A switch back path 25 for inverting the sheet surface after reading is established under the discharge tray. Also, a front cover and a rear cover are established to protect the apparatus. The sheet supply unit 3, the transport unit 5, the discharge unit 4, and the support frame are each mounted on a predetermined mounting location.

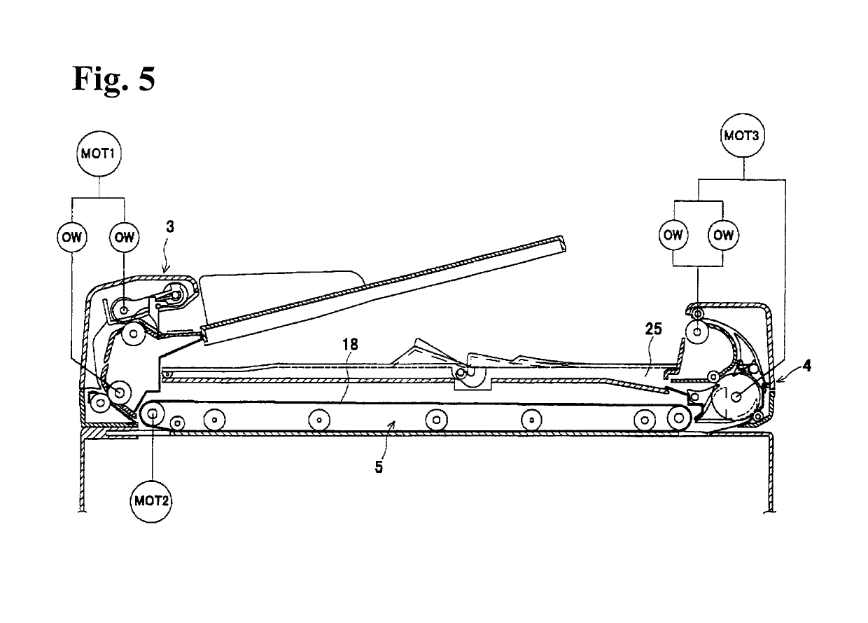

FIG. 5 shows an arrangement of drive motors for driving the transport device 1. The sheet supply unit 3, discharge unit 4 and transport unit 5 are equipped with a sheet supply motor MOT 1, a discharge motor MOT 3 and a transport motor MOT 2, which are capable of forward and reverse drive, to drive rollers of each unit.

In FIG. 1 and FIG. 3, the originals are stacked on the sheet supply tray 10 with a reading face up. The sheet supply unit 3 picks up the stacked original with facing upward. After inverted 180°, the original stops at a predetermined reading position under a transport belt 18 of the transport unit 5 with facing downward. The original is read at the reading position, rotated approximately 180°, and subsequently discharged to a top of the discharge tray 11 by the discharge unit 4.

When a plurality of originals is stacked on the sheet supply tray 11, a page order of the originals, which are eventually stacked on the discharge tray 11, is reversed when using the discharge method because the originals are drawn out and read continuously from the upper most sheet. To prevent this, after reading, the originals must be inverted before the discharge unit discharging them to the discharge tray 11. To do that, the originals are transported once into the switch back path 25 established on a backside of the discharge tray 11 (the inner side). Then the originals are discharged to the discharge tray 11 from a trailing edge of the original to be stacked in the initial page order.

In the transport device 1 shown in FIG. 1, the sheet supply tray 10 is mounted to an upper portion of the apparatus. The sheet supply unit 3 disposed on a left side supplies the originals to the transport unit 5 in an order from the uppermost sheet placed on the sheet supply tray 10. The discharge tray 11 is disposed below the sheet supply tray 10. The switch back path 25 is established below the discharge tray.

This invention is applicable to the first embodiment of a one-carriage reading method of the transport device 1 shown in FIG. 1, as well as the second embodiment of a two-carriage reading method shown in FIG. 3.

In the first embodiment shown in FIG. 1, the platen 30 disposed on the upper portion of the reading device 2 has the first reading position A for the stationary reading unit to read a moving original, and the second reading position B for the reading unit moving below the platen 30 to read an original placed stationary at the reading position on the platen 30.

As shown clearly in FIG. 1 and FIG. 2, the carriage 50 arranged in the reading device 2 for reading the originals is provided with a light source 4, mirrors 5a, 5b and 5c, a condensing lens 6 and a photoelectric conversion element (hereinafter referred to as an image sensor) such as a CCD in a carriage 50c. When reading an image data on the original transported by the transport device 1, the light source 4 positioned below the platen 30 along a main scanning direction of the original irradiates light on the original. The first mirror 5a, the second mirror 5b and the third mirror 5c send the light reflected from the original to the condensing lens 6. The image sensor receives the light focused by the light condensing lens 6.

According to this structure, when reading black and white originals, the carriage 50 stays at the first reading position A and reads the originals transported over the platen at the first reading position A. When reading color originals, the carriage moves from left to right (a sub-scanning direction) guided along a guide rod 79 below the second reading position B on the platen 30, while the originals is stationary at the second reading position B on the platen.

The image data, which is the light received by the image sensor 9, is converted to a digital signal in the reading device 2b and then sent to an image forming apparatus G such as a copier (not shown in the drawings).

In the second embodiment of the two-carriage method shown in FIG. 3 and in FIG. 4, the platen 30 disposed on the upper portion of the reading device 2 has the first reading position A and the second reading position B. The reading device moves below the platen 30 to read the original placed at the second reading position B.

The first carriage 50a has the light source 4 and the mirror 5f for reading the original, and the second carriage 50b has mirrors 5g and 5h. The optical reading device has two carriages to obtain finer image data of an original placed upon a platen by maintaining a constant distance of a light path between a reading position of the original and the photoelectric conversion element 60 when the optical reading means moves under the platen to scan and read the original.

When reading the original, the light source 4 irradiates light through the platen 30 on the original transported to the first reading position. The light is reflected by a plurality of mirrors 5f, 5g and 5h in the carriage 50. The image is formed on the image sensor by the condensing lens 6 arranged at a fixed position in the apparatus, and is then read by the image sensor that is the reading device such as a CCD.

Further, the reading device 2 is composed of the two carriages, namely the first carriage 50a having the light source 4 and mirror 5f for reading the original placed at the platen 30, and the second carriage 50b having the mirrors 5g and 5h and moving in a transport direction to read the images.

FIG. 1 and FIG. 2 show a drive mechanism of the optical reading device mounted on the carriage 50, which is the first optical reading device. The drive mechanism arranged in the reading device 2 is provided with a carriage transport motor 76; a guide rod 79 for supporting and guiding the carriage 50; a transport belt 75 engaged with the carriage through an engaging member 7 for transmitting a drive force from the transport motor 76; and a transmission belt 77 for transmitting the drive force to the transport belt 75.

The forward and reverse drive force of the carriage transport motor 76 is transmitted from the transmission belt 77 to the transport belt 75, and the carriage 50 engaged with the transport belt 75 moves in the scanning direction or in the opposite direction guided by the guide rod 79.

In FIG. 2, the carriage 50 moves to a position to read a final line of the original, and stops at a stopping position where the stopper 34 is established. A control device controls a moving speed by controlling the rotation of the carriage transport motor. In general, a pulse motor controls the rotation of the carriage movement motor 76 based on the number of imposed pulses.

When the reading scan of originals is completed, the carriage 50 is returned to the standard position A (the first reading position) by the reverse rotation of the carriage movement motor 76.

FIG. 3 and FIG. 4 show a drive mechanism of the carriage to in the second reading device. The drive mechanism configured in the reading device 2 is composed of a sliding rail 57 for supporting and guiding the two carriages 50a and 50b, a carriage movement motor 58, and a wire 59 interlocked to the carriages 50a and 50b and transmits a drive force from the motor.

A control device controls the movements of the carriages 50a and 50b, and the forward or reverse rotation of the carriage transport motor 58 is transmitted via the wire 59. The two carriages 50a and 50b moves in the scanning direction guided by the sliding rail 57.

In FIG. 3 and FIG. 4, a reference stopper 33 stops the original, when a trailing edge of the original abuts against the reference stopper 33 with the transport belt 18 moving in the opposite direction. Alternatively, it is also possible to stop the original without switching back when the trailing edge of the original passing over the reading position A. Therefore, FIG. 4 shows a state that the carriage 50 finishes reading the last line of the original.

As described above, in order to maintain the light path between the reading position and the photoelectric element at a constant distance, the first carriage 50a is controlled to move over twice the distance of the second carriage 50b at a predetermined speed. The moving speed of the carriages 50a and 50b is controlled at a reading speed for each of the reading modes, based on whether the original is in monotone or color, which is described in detail below. When the scan of the originals is completed, the carriage movement motor 58 rotates in reverse to return the carriage to the standard position 33 (the first reading position).

According to the present embodiments, a transport speed of the original to the first reading position A on the platen is set at 50 cpm (216 mm/sec), which is an actual reading speed for black and white originals. At this speed, while reading the image data, it is determined whether the image data is in monotone or color. When the original includes the color images, the original is set at the second reading position B and the reading carriage 50 reads the original by moving from the original supply side to the discharge side. A moving speed of the reading carriage 50 is set at 25 cpm (108 mm/sec) to read the color images. The color originals can be read with great accuracy at this speed. When the original is in black and white, the original is not set at the second reading position B, but is discharged, to process the monotone originals, which are the most predominant type, at a higher speed.

Next, a structure and a method for reading a set of originals including both monotone and color originals. The first and the second embodiments of the present invention have the structure and method for reading such a set of originals in common. The following will describe the image reading method according to the present invention in detail.

First, a method of determining whether an image is in monotone and color will be explained.

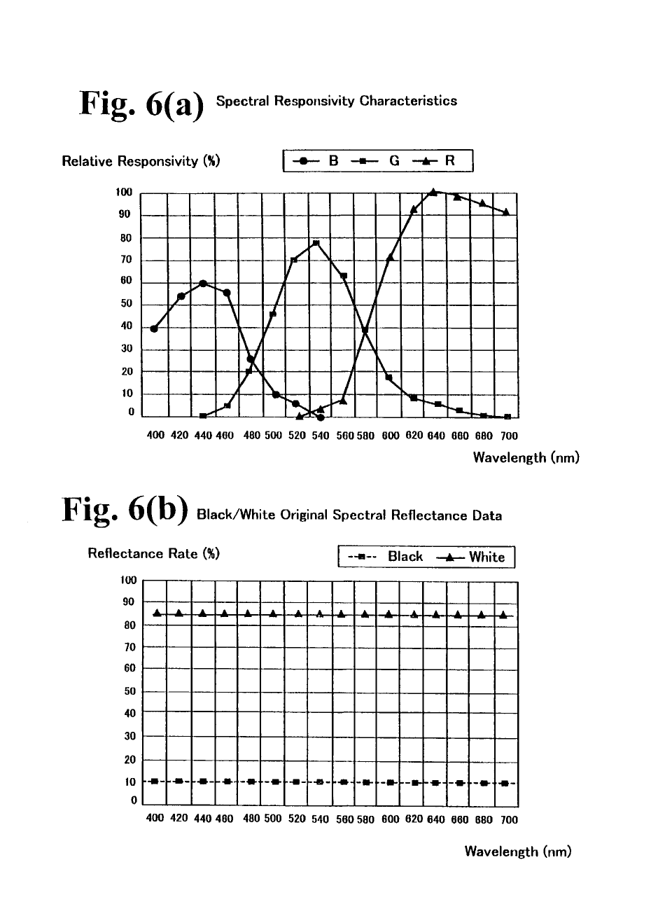

FIG. 6(a) is a graph showing a relationship between relative sensitivity and wavelength of color for each sensor, and FIG. 6(b) is a graph showing spectral reflectance data of a monotone document. As shown in FIG. 6(a), since each line sensor, R, G and B, has a spectral sensitivity peak at a different wavelength, when reading a color document, each line sensor generates maximum output at a different wavelength. On the other hand, as shown in FIG. 6(b), a monotone (black and white) document shows a constant spectral reflectance rate regardless of the wavelength. In the figure, each line sensor generates a constant high output for white pixels and a constant low output for black pixels. Because of this difference, it is possible to determine whether an original to be read is either in color or monotone. Note that since it is possible to determine color or not by checking the peak wavelength of the line sensor output, even when reading a document at high speed, this operation becomes possible.

In this way, the color detection unit (the determining unit) in this invention is configured to receive an output from a shading correction unit (described later) converted into a digital signal at the red, green and blue line sensors. When there is a difference in the output patterns from the sensors, it is determine to be a color document. In the case of no difference, it is determined to be a black and white document.

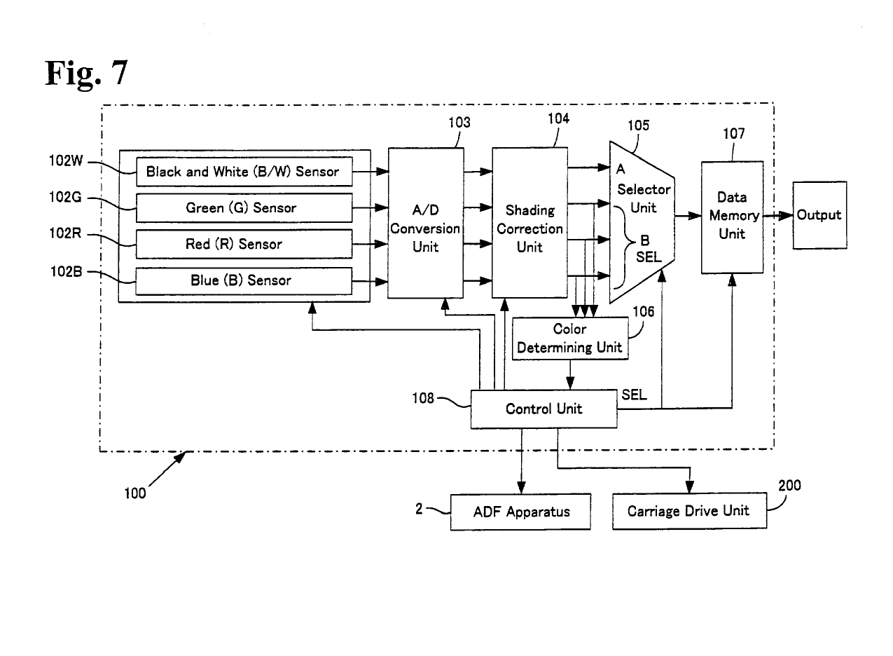

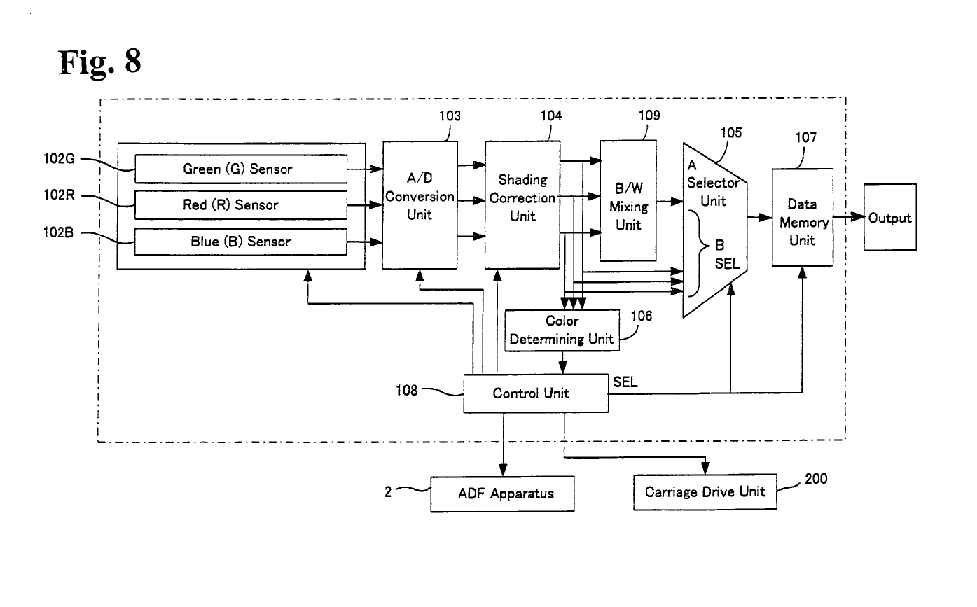

In the next embodiment of the present invention, an image-signal control apparatus (hereinafter referred to as a control apparatus) is provided a data memory unit 107 (FIG. 7 and FIG. 8) to sequentially store image data read by the reading device. Depending on the type of image reading apparatus, it is possible to output image data from the reading means, without a data memory to store the image data, to an image forming apparatus after processing correction of the image data. In such a case, in applying the invention, the detection device uses the processed signal of the image data from the reading means to determine whether the image data is in monotone or color.

FIG. 7 shows a circuit configuration of a control apparatus 100 having four line sensors, namely three line sensors of red (R), green (G) and blue (B) and a black and white (B/W) sensor. The control apparatus 100 shown in FIG. 7 includes an A/D conversion unit 103 to convert analog data read by the four line sensors 102W, 102R, 102G and 102B into digital data; a shading correction unit 104 for correcting a shading of the converted data (sensitivity correction between photoelectric conversion elements); a color detection unit 106 (a determining unit) for determining a gradation of the shading corrected data; a control unit 108 for receiving a result determined by the color detection unit and outputting a signal to control the image reading apparatus; a selector unit 105 for switching and outputting monotone data or color data according to a SEL signal from the control unit 108; and a data memory unit 107 for storing the image data after switching between a monotone mode and a color mode according to the SEL signal from the control unit 108, and outputting it to the image forming apparatus.

In the control circuit shown in FIG. 7, image data from the black and white sensor 102W is used as image data in the first reading mode (the monotone reading mode), at the same time, it is determined whether it is a color original based on the output from the green sensor 102G, the red sensor 102R and the blue sensor 102B.

Note that a signal from the control unit 108 is configured to be transmitted to the ADF apparatus 2 control unit, which controls a rotating direction and a speed of the transport device sheet supply motor M1 and transport motor M2, and the carriage drive unit 200 that controls a rotating direction and a speed of the carriage transport motors 58 and 76. Therefore, the aforementioned control circuit recognizes whether the original has a color image using the color detection device while reading the transported originals. Also, the control circuit has a switching control device to switch the drive speed of the carriage transport motors 58 and 76 between a high speed and a low speed.

FIG. 8 shows an image signal control unit 100b having three line sensors of red (R), green (G) and blue (B). The image signal control unit 100b includes the A/D conversion unit 103 to convert analog data read by the three line sensors 102R, 102G and 102B into digital data; the shading correction unit 104 for correcting a shading of the converted data (sensitivity correction between photoelectric conversion elements); a monotone mixing conversion unit 109 for producing a black signal based on the shading corrected data; the color detection unit 106 (the determining unit) for determining a gradation of the shading corrected data; the control unit 108 for receiving a result determined by the color detection unit and outputting a signal to control the image reading apparatus; a selector unit 105 for switching and outputting monotone data or color data according to a SEL signal from the control unit 108; and a data memory unit 107 for storing the image data after switching between a monotone mode and a color mode according to the SEL signal from the control unit 108, and outputting it to the image forming apparatus. Therefore, in the control circuit shown in FIG. 8, image data in the first reading mode (the monotone reading mode) is combined data (an AND output) from the green sensor 102G, the red sensor 102R and the blue sensor 102B. Again, based on whether there is a difference in the output patterns from the green sensor 102G, the red sensor 102R and the blue sensor 102B, it is possible to determine whether the original is in color or black and white.

Similar to the case in FIG. 7, the signal from the control unit 108 is transmitted to the ADF apparatus 2 control unit, which controls the rotating direction and the speed of the transport device sheet supply motor M1 and transport motor M2, and the carriage drive unit 200 to control the rotating direction and the speed of the carriage transport motors 58 and 78.

Therefore, the control circuit includes the color detection device for determining whether it is a color document while reading a black and white image, and the switching control device to switch the speed of the carriage transport motors 58 and 76 between a high speed and a low speed.

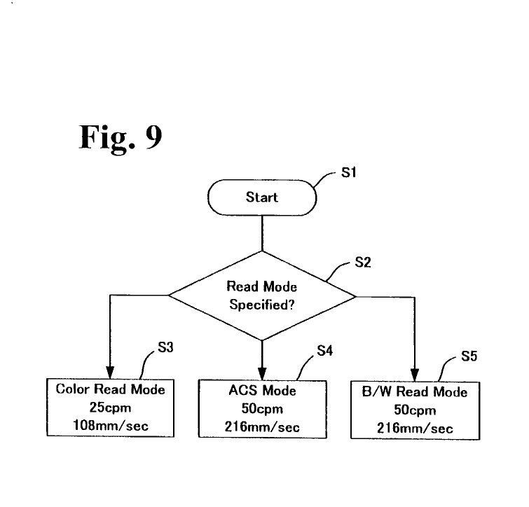

A flow chart of reading control according to the embodiment of the present invention will be explained next. An operator selects the reading mode (S1) shown in FIG. 9, when the image reading apparatus (S2) start to read an original. When the color reading mode is selected (53), the image reading apparatus reads at a low speed of the color reading mode (25 CPM/108 mm/sec). When the monotone reading mode is selected (S5), the image reading apparatus reads at a high speed of the monotone reading mode (50 CPM/216 mm/sec). When an auto-color select (ACS) mode is selected (S4), the reading control described below is executed according to the invention.

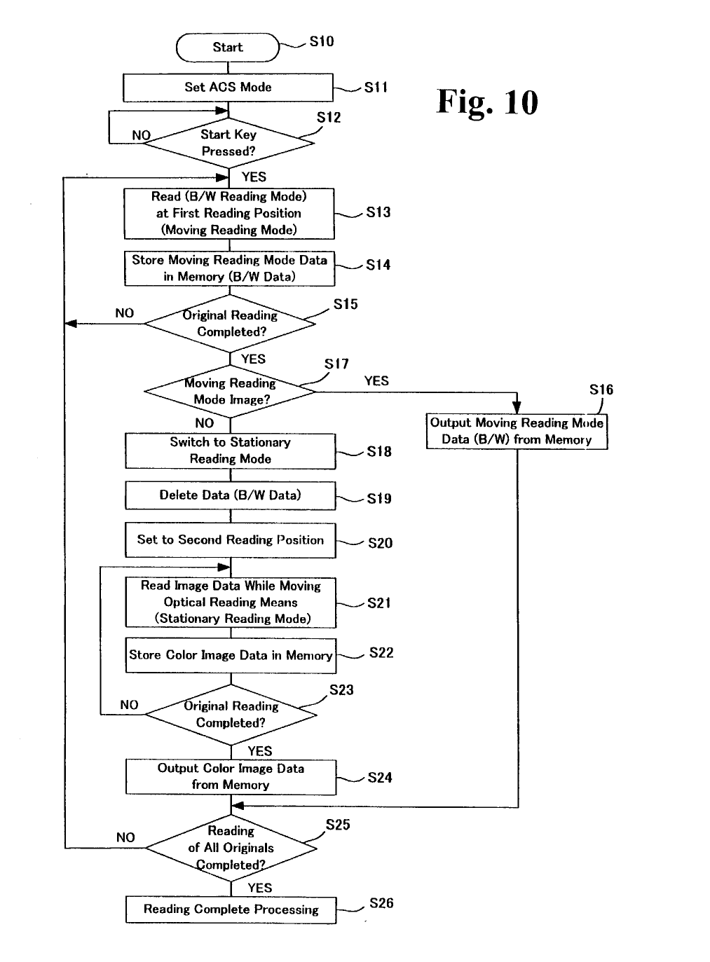

FIG. 10 shows the first control method of the image reading operation according to the present invention. A flow chart in the FIG. 10 shows the control method to determine the reading mode after reading the original using the first reading mode (the reading mode while transporting).

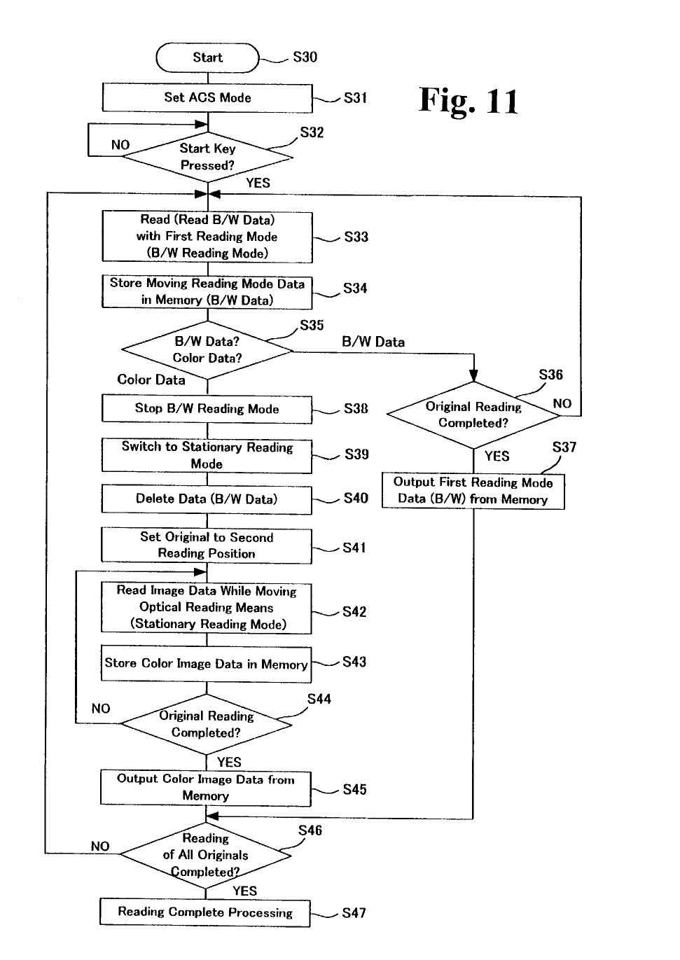

FIG. 11 shows the second control method of the image reading operation according to the present invention. FIG. 11 shows a flow chart of the control method to determine a type of image data while reading the original

In FIG. 10, the reading operation starts after placing the original on the supply tray (S10). After the ACS mode is selected (S11), reading of the original starts (S13) in the first reading mode when a start key is pressed (S12) on the image reading apparatus. In the first reading mode, the optical reading device is stationary under the platen, and reads the original that is transported and moving on the first reading position. In the second reading mode, the optical reading device reads the original that is set at the second reading position on the platen while the optical reading device is moving.

According to the embodiment of the present invention, a moving speed of the original passing over the first reading position is set at 50 cpm/216 mm/sec. When the originals include the color images, the moving speed of the optical reading device to read the originals placed stationary on the second reading position is set at 25 cpm/108 mm/sec. The speed may be variable according to performance of the reading elements.

Image data read in the first reading mode is stored (S14) in the memory as image data of the first type (the monotone data). As described in relation to FIG. 7 and FIG. 8, an analog signal of the original read by the line CCD sensor 102 is converted into a digital signal by the A/D converter unit 103, then, the image data is shading corrected by the shading correction unit 104, output to the selector unit 105 and stored in the memory.

When the reading of the original in the first reading mode is completed (S15), the color detection unit 106 determines the type of stored data (S17). In this step, it is determined whether the image data corresponds to the transport reading mode (monotone) or the stationary reading mode (color). If it is determined that the data applies to the transport reading mode (the monotone data), the image data stored in the data memory 107 is output to the image forming apparatus (S16) and the reading of the original image is completed. If the image data stored in the data memory 107 is determined to be suitable for the stationary reading mode (the color data), the apparatus reading mode switches from the transport reading mode to the stationary reading mode (the color reading mode) to read the color original at a slower speed (S18). The image data (the monotone data) read and stored in the data memory unit 107 as the black and white data is deleted (S19).

Then, the original is set at the predetermined second reading position (a fixed reading position)(S20), and the optical reading means is moved to scan and read the image data on the original in the stationary reading mode (the color reading mode) (S21). The original can be transported in the discharge direction on the platen or can be fed back toward the direction opposite to the discharge direction to be set at the second reading position. Alternatively, the originals can also be stopped at the position where the trailing edge thereof has passed the first reading position A.

In the stationary reading mode (the color reading mode), the optical reading device moves at a slower speed than the transport reading mode (the monotone reading mode). The image data on the original (the color image data) read in the stationary reading mode is stored sequentially in the data memory 107 (S22). When the apparatus continues to read the originals, the original reading operations (S21 and S22) are performed. When the reading of images on the original using the stationary reading mode is completed (S23), the color image data stored in the data memory 107 is output to the image forming apparatus (S24). There, if a new original is placed on the platen, the reading operation is performed (S25 and S26).

FIG. 11 is an example of the second image reading operation control of the present invention. Here, differing from the aforementioned second control method, the invention determines whether the data being read is black and white or color while it is reading the original.

In FIG. 11, the reading operation starts after placing the original at a predetermined position on the platen (S30). Here, after the ACS mode is selected (S31), the ADF2 starts to transport the original when the start key is pressed (S32) on the apparatus. When the original is transported at the reading position 3, the image reading apparatus 1 starts reading in the first reading mode (S33). In the first reading mode, the optical reading device is stationary under the platen, and reads the original that is transported and moving on the first reading position. In the second reading mode, the optical reading device reads the original that is set at the second reading position on the platen while the optical reading device is moving.

The image data read in the first reading mode (the monotone reading mode) is stored (S34) in the memory as data of the transport reading mode (the monotone data). As described in relation to FIG. 7 and FIG. 8, an analog signal of the original read by the line CCD sensor 102 is converted into a digital signal by the A/D converter unit 103, then, the image data is shading corrected by the shading correction unit 104, output to the selector unit 105 and stored in the memory.

Next, in the example of the second image reading operation control, which is different from the example of the first image reading operation control, it is determined whether the image data sequentially read while reading the images on the original is the first type (the black and white data) or the second type (the color data) (S35). When it is determined that the data is the first type (the black and white data), it is continued to read in the first reading mode. When it is determined that all the data is the first type (the black and white data), the image data stored in the data memory 107 is output to the image forming apparatus (S37) and the reading of the original image is completed. Then, the original is discharged to the discharge path 18.

When the image data on the original is determined to be the second type of data (the color data), the reading in the first reading mode is stopped (S38). The apparatus switches from the first reading mode to the second reading mode (the color reading mode) to read the color original at the slow speed (S39). The image data (the black and white data), which is read in the first reading mode and stored in the data memory unit 107 as black and white data, is deleted (S40).

Then, the original is set at the predetermined second reading position (the fixed reading position)(S41), and the optical reading means is moved to scan and read the image data on the original in the stationary reading mode (the color reading mode) (S42). The original can be transported in the discharge direction on the platen or can be fed back toward the direction opposite to the discharge direction to be set at the second reading position. Alternatively, the originals can also be stopped at the position where the trailing edge thereof has passed the first reading position A.

In the stationary reading mode (the color reading mode), the optical reading device moves at a slower speed than the transport reading mode (the monotone reading mode). The image data on the original (the color image data) read in the stationary reading mode is stored sequentially in the data memory 107 (S43). When the apparatus continues to read the originals, the original reading operations (S42 and S43) are performed. When the reading of images on the original using the stationary reading mode is completed (S44), the color image data stored in the data memory 107 is output to the image forming apparatus (S45). There, if a new original is placed on the platen, the reading operation is performed.

As described in detail above, the image reading apparatus of the present invention is provided with the supply device for supplying the original on the supply tray; the transport device for transporting the original supplied from the supply tray to the platen; the discharge device for discharging the original on the platen; the optical reading device for scanning the stationary original placed on the platen to read the image data; the drive device for moving the optical reading means at the first moving speed and the second moving speed; the detection device for determining the type of image data read by the optical reading means as either the first type of data or the second type of data; the scan control device for obtaining and storing the image data while scanning the document at the first moving speed; and the switching control device for switching the drive device to the second moving speed when the detecting device determines the image data read at the first moving speed to be the second type of data.

In the first reading mode, the optical reading device is stationary under the platen, and reads the original that is transported and moving on the first reading position. In the second reading mode, the optical reading device reads the original that is set at the second reading position on the platen while the optical reading device is moving. A reading speed in the first reading mode is faster than that in the second reading mode. The first reading mode is for reading the monotone images, and the second reading mode is for reading the color images.

When reading the image on the monotone original, the image data obtained in the initial reading operation will be used, thereby eliminating the second scanning. Therefore, it is possible to read a set of originals containing both the monotone originals and the color originals at a higher speed. Also, the apparatus reads the color original with a higher quality in the actual scanning (the second reading operation).

Furthermore, according to the invention, when the image data on the original is determined to be the color image data by the detection device while the optical reading device is reading the original in the monotone mode, the apparatus stops reading in the monotone reading mode and starts reading the original in the color reading mode. Thus, the image reading apparatus according to the invention can read a set of originals including both monotone image and color image at a faster processing speed.

As described above, in determining the type of image data, the apparatus reads the monotone data. However, other than the color and monotone originals, this invention is also applicable to an image reading apparatus where the apparatus reads either a text or halftone original in determining whether the original has a text or halftone, and the apparatus reads one of text and halftone image in the stationary reading mode, and reads the other in the transport reading mode.

While the invention has been explained with reference to the specific embodiments of the invention, the explanation is illustrative and the invention is limited only by the appended claims.

What is claimed is:

1. An image reading apparatus for reading an image on an original, comprising:
a platen,
a supply tray for storing the original,
supply means disposed adjacent to the supply tray for drawing out the original on the supply tray,
transport means for transporting the original from the supply means to the platen,
reading means arranged under the platen for reading the image on the original on the platen in a first reading mode or second reading mode;
detection means electrically connected to the reading means for determining whether the image read by the reading means is a first kind of image or a second kind of image; and
switching control means electrically connected to the reading means and the detection means, said switching control means stop-reading the original in the first reading mode when the detection means determines the image read in the first reading mode to be the second kind of image while the data is being read by the reading means, and reading the original by the second reading mode.

2. An image reading apparatus according to claim 1, further comprising discharge means disposed adjacent to the platen for discharging the original on the platen, and reading mode setting means electrically connected to the reading means for selecting one of the first reading mode and the second reading mode, said switching control means operating the discharge means to discharge the original when the detection means determines the image read in the first reading mode to be the first kind, and operating the reading mode setting means to switch from the first reading mode to the second reading mode when the detection means determines the image read in the first reading mode to be the second kind.

3. An image reading apparatus according to claim 2, wherein said reading means is stationary under the platen and reads the original moving on the platen in the first reading mode, and said reading means is moving under the platen to read the original placed stationary on the platen in the second reading mode.

4. An image reading apparatus according to claim 2, wherein said reading means reads the original in the first reading mode at a speed higher than that in the second reading mode.

5. An image reading apparatus according to claim 3, wherein said reading means reads a monotone image in the first reading mode, and reads a color image in the second reading mode.

6. An image reading apparatus according to claim 3, wherein said reading means reads a binary scale image in the first reading mode, and reads a multiple scale image in the second reading mode.

7. An image reading apparatus according to claim 1, wherein said first kind of image is a monotone image and said second kind of image is a color image, said control means operating to stop-read the original in a monotone reading mode when the detection means determines the image read in the monotone reading mode to be the color image, and to read the original in a color reading mode.

8. An image reading apparatus according to claim 7, wherein said reading means is stationary under the platen and reads the original moving on the platen in the monotone reading mode, and said reading means is moving under the platen while reading the original placed stationary on the platen in the color reading mode.

9. An image reading apparatus according to claim 8, wherein said reading means reads the original in the monotone reading mode at a speed higher than in the color reading mode.

10. An image reading method for reading an image on an original on a platen of an image reading apparatus, comprising the steps of:
reading the original moving on a platen in a transport reading mode by reading means located at a first reading position to obtain image data;
determining whether the image data read in the transport reading mode is suitable for the transport reading mode;
setting the original to a second reading position on the platen if the image data read in the transport reading mode is determined to be unsuitable for the transport reading mode; and
reading said original placed at the second reading position on the platen by the reading means in a stationary reading mode.

11. An image reading method according to claim 10, wherein if the image data read in the transport reading mode is determined to be suitable for the transport reading mode, the image date is output and the original is discharged.

12. An image reading method according to claim 11, wherein the step of setting the original includes transporting the original downstream or upstream to be located on the second reading position.

13. An image reading method according to claim 11, wherein in said reading step, the original in the transport reading mode is read at a speed faster than in the stationary reading mode.

14. An image reading method according to claim 11, wherein said transport reading mode reads a monotone image, and said stationary reading mode reads a color image.

15. An image reading method according to claim 11, further comprising the step of stop-reading the original in the transport reading mode if the image data read in the transport reading mode is determined to be a color image in a monotone reading mode, the original being set to the second reading position for reading.

16. An image reading method according to claim 15, wherein the step of setting the original includes transporting the original downstream or upstream to be located on the second reading position.
